(19) United States
(12) Patent Application Publication
(10) Pub. No.: US 2022/0007090 A1
(43) Pub. Date: Jan. 6, 2022

(54) Digital remote air gauge

(71) Applicants: Joseph Petrucelle, Hudson, WI (US); Christian Kuhn, Loveland, OH (US)

(72) Inventors: Joseph Petrucelle, Hudson, WI (US); Christian Kuhn, Loveland, OH (US)

(21) Appl. No.: 16/920,434

(22) Filed: Jul. 3, 2020

(51) Int. Cl. H04Q 9/00; G01L 9/00; G01L 19/08

(52) U.S. Cl. CPC H04Q 9/00; G01L 9/00; H04Q 2209/82; H04Q 2209/40; H04Q 2209/88; G01L 19/086

(57) ABSTRACT

A unit wirelessly communicates data about the air pressure of a connected body, in this case an air brake line, with another unit having equipment to display this data to an end user. Units can be operated without any other physical external connection, allowing for flexibility in practical usage. The units may, in certain configurations, offer a user interface, collect and store data, and create mesh networking/storage systems with other units. Additional metrics may be collected and transmitted using the underlying communication system. In any case, the invention improves the efficiency and value of FRA required air brake pressure testing.

### CROSS-REFERENCE TO RELATED APPLICATION(S)

No priority benefit is claimed in connection with this application for patent.

### STATEMENT REGARDING FEDERALLY SPONSORED RESEARCH/DEVELOPMENT

This invention was made without government support, through any means or by any Federal agency. The government does not have rights to this invention.

### STATEMENT REGARDING A JOINT RESEARCH AGREEMENT

This invention is not the result of any joint research agreement, and as such a disclosure of contracted parties is not supplied or required.

### INCORPORATION-BY-REFERENCE OF MATERIAL

No supplemental material is sought to be incorporated in this patent application besides the information contained herein.

### STATEMENT REGARDING PRIOR DISCLOSURES

At no point has either joint inventor made any public disclosures, statements, use or sale of any part of the invention claimed and described by this application.

### SEQUENCE LISTING

37 CFR Sections 1.821-1.825 do not apply to this application.

### FIELD OF INVENTION

For classification purposes, this invention can be considered to be a data telemetry system applicable for use in the field of railroad operations and safety testing.

### BACKGROUND ART

We contend that the closest significant art of record to this application is that of Kane et. al. (filed January 2011, U.S. Pat. No. 7,872,591-B2), which was of reference in the first Office Action. It is our opinion that the amendments filed May 14, 2021 provide clearer distinction from this prior art and have provided remarks providing our reasoning for patentability over Kane. Namely, we hold that under MPEP 2143.01 (V), the obvious modifications to Kane's claims would render the device inoperable for its original purpose given the limitations. As such, the other cited prior art raised by the Office Action need not be considered related art as the basis for their inclusion was as part of a judgement in conjunction with Kane et. al., which we further differentiate from in the remarks of our reply to this Office Action.

### BRIEF SUMMARY OF THE INVENTION

Per the Federal Railroad Association and pursuant to 49 CFR § 232, railroads operating within the United States are required to execute tests that confirm the integrity of air brake components. These tests occur at various intervals throughout the “lifetime” of a set of cars. The aforementioned legislation requires a pressure reading device to be attached to the end of the train, whereas the locomotive (which supplies and controls the air brake pressure) is typically located at the front of the train. Thus, considering a typical train is in excess of a mile in length, these pressure tests require either multiple railyard engineers placed at opposite ends of the train or require additional time so that a single engineer can walk the length of the train to collect a reading from the gauge. In either scenario, railroad company money is lost to unnecessary labor costs. Our invention allows for a single employee to perform these tests in a comparably smaller amount of time, with greater accuracy and less training, and allows for the collection of performance data for safety and insurance analysis purposes. By transmitting the pressure data wirelessly from the rear of the train to a device used by a railyard engineer/conductor in real time, adjustments in air pressure can be made (and their effects observed) without having to traverse the length of the train to read a traditional analog gauge. Because the unit used by an employee to receive this data wirelessly requires no physical connections, it can be used while moving about the cars and observing proper setup of braking mechanisms as required, or in any other location within the physical range limits of the wireless transceivers. Finally, the ability for units to record and share data provides an additional level of data integrity and affords operating companies a stronger proof of diligence when tests are completed and saved digitally, especially since multiple copies of the data can be saved across separate units.

### BRIEF DESCRIPTION OF DRAWINGS

FIG. 1, the depiction on Sheet 1, is the only drawing for this patent application. It depicts the two separate physical units our system comprises, as well as a set of cars for visual reference in use. Bold text is used sparingly to aid in the recognition of certain abstract electrical objects.

### DETAILED DESCRIPTION OF THE INVENTION

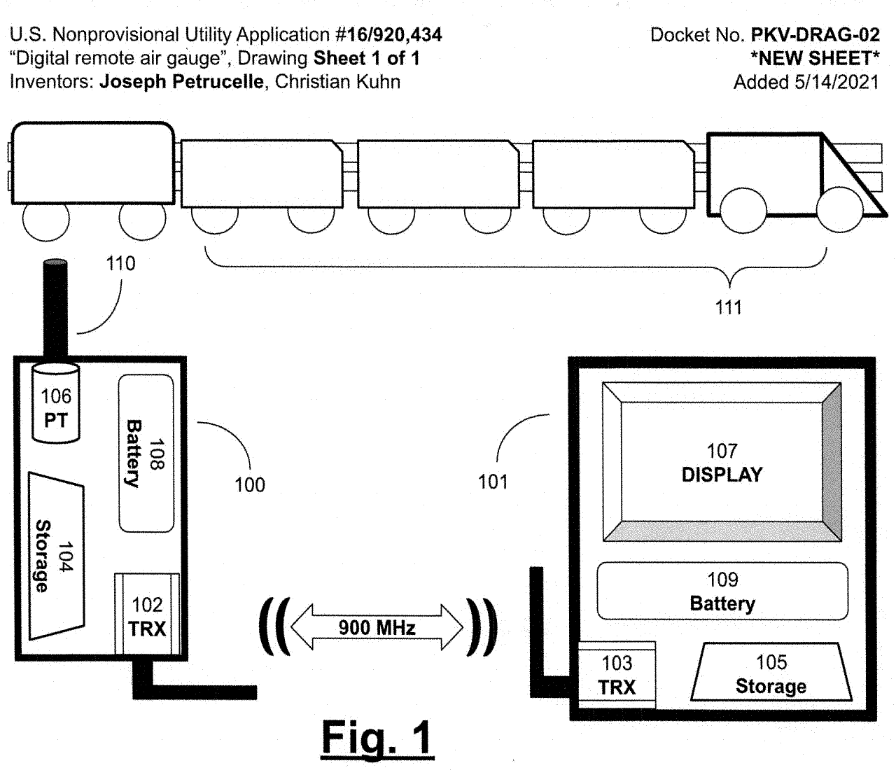

As presented in FIG. 1, this invention comprises the two separate physical units 100 and 101, shown in a boldened box which can be thought to represent an enclosure of appropriate nature for telemetry electronics. The configuration shown includes limitations described in claim 4, where both units contain a battery (108/109) and can operate independently, without needing any other physical external connection except at the point where the pressure transducer (PT) 106 mounts with an adjacent container shown by the fitting 110. A set of train cars 111 is shown for reference, with the end being positioned nearest to fitting 110 on unit 100, since this is where the device is mounted during operation. (Neither fitting 110 or the set of cars 111 are covered under this patent.) Unit 101, however, can be used anywhere within the limits of the wireless signal from unit 100 since it does not necessitate attachment to any fixed object or any other form of external physical connection. The limit of this system is defined by the wireless transceiver radios 102 and 103 shown in each physical unit; the inclusion of a short tail antenna and radio graphics with the “900 MHz” label serve as an example technology which fits the limitations of the claims but is not the only possible application for the purposes of wireless communication within the scope of this invention. Digital storage medium 104 can record data from both the transducer 106 directly and from transmissions received by the onboard wireless transceiver 102. Digital storage medium 105 can also record information from its own onboard transceiver 103, as well as from an onboard display 107 if the panel in question is equipped with a touch sensing method. In an application of this invention where a display is not used, optional alternate means of determining user input could also exist as buttons, a keypad, keyboard, pointer, slider, etc. Any detected user inputs through these means or from a display 107 that is so equipped to detect input can then be passed to transceiver 103 and sent to transceiver 102 on the opposite unit 100, to be saved on its own storage medium 104 in addition to the storage medium 105 on unit 101 where the interaction occurred. In normal operation, though, the flow of information will be reversed from this operation. Normally, separate physical unit 100 will be transmitting (via transceiver 102) data from the onboard transducer 106 while also saving the data to its own storage medium 104. Unit 101 will receive this data with its transceiver 103 and present the information to the user in a proper form by way of display 107 (or an alternative; see claim 1) while also recording the information to the onboard digital storage medium 105.

Please note that none of these numbered objects are drawn to scale and are provided visually for ease of understanding only. Contents of each separate physical unit can vary and may exceed the basic requirements imposed by the claim limitations of this application.

We, the joint inventors, claim:

1. A system comprising: two separate physical units, each equipped with a radio system for the purpose of wireless communication and a digital storage medium for the purposes of recording information including, but not limited to, wireless communications sent and received,
wherein one of the two separate physical units is equipped with a transducer for the purposes of determining the air pressure present in an adjacent container and wirelessly transmitting the result, and
wherein the other of the two separate physical units is equipped with a display, dial gauge, speakers, or similar audio-visual equipment to allow for the interpretation of wirelessly received communication, including any information recorded on the digital storage medium, also being equipped with an internal battery such that no physical external connections are required.

2. (canceled)

3. (canceled)

4. The system of claim 1 wherein the separate physical unit which is equipped with a transducer is also operated by means of its own internal battery power, such that it requires no physical external connections of electrical nature.

5. (canceled)

6. The system of claim 1 wherein the radio system constitutes wireless transceiver radio modules in each of the separate physical units, such that each unit is simultaneously capable of both transmitting and receiving wireless communications at any time, which can then be recorded in the digital storage mediums as accessible information.

7. (canceled)

8. The system of claim 6 wherein the audio-visual equipment includes a touchscreen panel, buttons, knobs, or similar equipment for the purpose of detecting user input, which can then be recorded in the on-board digital storage medium as accessible information and can be transmitted to, and recorded to the digital storage medium of, another separate physical unit for the purposes of data integrity and accessibility.
